(19) United States
(12) Patent Application Publication
(10) Pub. No.: US 2012/0012673 A1
(43) Pub. Date: Jan. 19, 2012

(54) SPRAYER BOOM FOR A FIELD SPRAYING DEVICE

(76) Inventor: Albert Hedegaard, Holstebro (DK)

(21) Appl. No.: 12/678,893

(22) PCT Filed: Sep. 19, 2008
(86) PCT No.: PCT/DK08/50228

§ 371 Date: Oct. 6, 2011

(30) Foreign Application Priority Data
Sep. 19, 2007 (DK) PA 2007 01352

(51) Int. Cl. B05B 1/20

(52) U.S. Cl. 239/165

(57) ABSTRACT

The invention states a sprayer boom and a field spraying device comprising a liquid container attached to a portable frame and with at least one sprayer boom. Said sprayer boom comprises a number of sprayer nozzles as well as a number of downward directed air nozzles supplied with air from a central fan. Said sprayer boom is telescopic and displays a number of air nozzles arranged on one or more pipe sections.

The invention relates to a field spraying device comprising a liquid container attached to a portable frame and with a sprayer boom on each side, said sprayer booms comprising a number of sprayer nozzles and a number of downward directed air nozzles that are supplied with air from a central blower.

A field spraying device of this type is known from e.g. EP 0 326 045 A. Arranged alongside the sprayer boom is an inflatable airbag with downward directed air cracks as well as a number of sprayer nozzles arranged so that an atomization of air and liquid blended together can take place and an even distribution of the sprayer liquid onto the field and the crop is ensured. On this kind of field spraying device, the sprayer boom displays a right and a left boom which can be folded together separately along the central unit where the liquid container and the air fan are arranged. Hereby the field spraying device can be transported to and from the field to where it is operated and stored.

However, the spraying width of this type of field spraying device is limited because the length of the sprayer boom is restricted since the bag does not contribute to stiffness in the construction and the sprayer boom therefore has to carry the weight of both the air bag, the arrangement of the liquid distributor attached to the boom as well as its own weight. Furthermore the sprayer boom can be operated only in its full length, which limits the general utilization of the field spraying device.

It is therefore the object of the invention to procure a field spraying device with a sprayer boom, which enables the delivery of air and sprayer liquid in a wider and more adjustable spraying width so that a given field area can be sprayed more rapidly.

This object is according to the invention achieved by a field spraying device comprising a liquid container attached to a portable frame and with a sprayer boom on each side, said sprayer booms comprising a number of sprayer nozzles and a number of downward directed air nozzles that are supplied with air from a central blower, where the sprayer booms are telescopic. The invention also concerns a sprayer boom which is telescopic for mounting on a field spraying device.

With a field spraying device according to the invention, a length adjustable sprayer boom is provided which makes it possible to adjust the spraying width of the field spraying device. It is with the invention furthermore realised that the sprayer booms on each side of the field spraying device can be individually adjusted to establish a non-symmetrical spraying pattern. It is furthermore realised that a telescopic sprayer boom according to the invention can be retrofitted as a spare part to existing field spraying devices, just as the sprayer boom according to the invention can be constructed symmetrically so that it can be used as either a right or a left sprayer boom on a field spraying device.

With a field spraying device according to the invention there can furthermore be achieved a wider spraying width as the sprayer boom according to the invention is at least partially self-supporting as the air transported inside the boom is exhausted in a downward directed flow by which the boom are blown upwards and thereby stabilised as the downward directed air flow will counteract the weight of the boom.

A field spraying device according to the preferred embodiment of the invention is on each side of the liquid container supplied with a sprayer boom which is pivotally hanged up in the mobile frame. In addition to adjusting the length of the two sprayer booms on the field spraying device, the booms are also able to be swivelled into a transportable position.

In the preferred embodiment of the invention the sprayer boom displays a number of pipe sections with different diameters and with downward directed air nozzles. At the end of each pipe section there are preferably arranged bushings, in which the pipe section inside slides in and secures a tight passage between the two pipe sections, just as there in connection with the bushings, advantageously can be arranged means to prevent the separation of the pipe sections. Depending on the desired spraying pattern, one or more of the pipe sections on the sprayer boom can be constructed without air nozzles.

The pipe sections are preferably constructed in fibreglass. Thereby a non-corrosive sprayer boom with a relative low weight is obtained.

According to the invention, means for reciprocal lateral movement of the pipe sections are arranged in connection to the sprayer boom, so that the length of the sprayer boom can be respectively elongated or decreased. These means of lateral movement can include one or more pneumatic activated actuators, one or more electrically activated actuators and/or a wire pull.

In one embodiment of the invention, one or more of the pipe sections in the sprayer boom are provided with a deformation zone such as a radial oriented zone with a lower breaking strength. Hereby it is secured that only a relatively small amount of damage is done to the field spraying device in case of a collision during driving. Each pipe section as well as other additional components can be replaced individually, by which easy and relative inexpensive reparation and a healthy operating economy can be ensured.

In another embodiment of the invention a flexible bag e.g. a plastic bag, which will be able to give in, in case of a collision, is attached to the outermost pipe section.

In the preferred embodiment of the invention, the sprayer nozzles for spraying the sprayer liquid are arranged on a nozzle pipe which is attached to the outer side of each pipe section and which is in connection with the flow from the liquid container through a liquid pump. Preferably the nozzle pipes are attached axial moveable on the pipe sections. Thereby a moveable arrangement is secured which easily and automatically follows the pipe sections when the sprayer boom is ejected and retracted.

Furthermore the nozzle pipes are preferably arranged in front of the air nozzles according to the driving direction of the field spraying device. Thereby a good atomization of the spraying liquid which is sprayed from the sprayer nozzles is secured. It is especially preferred that the two spraying directions of respectively the liquid and the air have a mutual angular direction in which the angle is acute.

In the preferred embodiment of the invention, the field spraying device is provided with a sprayer boom on each side of the liquid container. It is however by the invention realised that the field spraying device according to the invention also can be realised with only one sprayer boom.

In a first embodiment of the invention the sprayer boom displays a substantially circular cross section. Pipe sections with such a cross section are relatively simple and thereby inexpensive to produce. It is however realised by the invention that other cylindrical cross section forms also can be used, e.g. where the sprayer boom displays a cross section with an axial oriented cavity wherein the nozzle pipes are arranged. Hereby the nozzle pipes will be protected against impacts and similar and thereby damage to the nozzle pipes during operating of the field spraying device will be reduced. Furthermore it is by the invention realised that a non-circular cross section form can be chosen by which the sprayer boom achieves a greater bending stiffness so that a wider spraying width can be achieved than when using a circular cross section.

The invention is described in greater detail below with reference to the accompanying drawings in which:

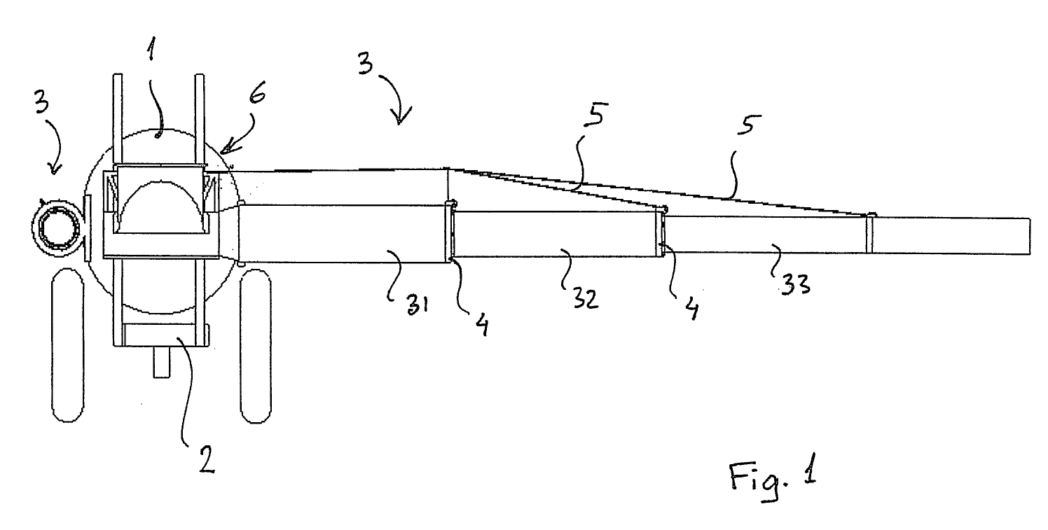

FIG. 1 is a schematic drawing of a field spraying device according to the invention.

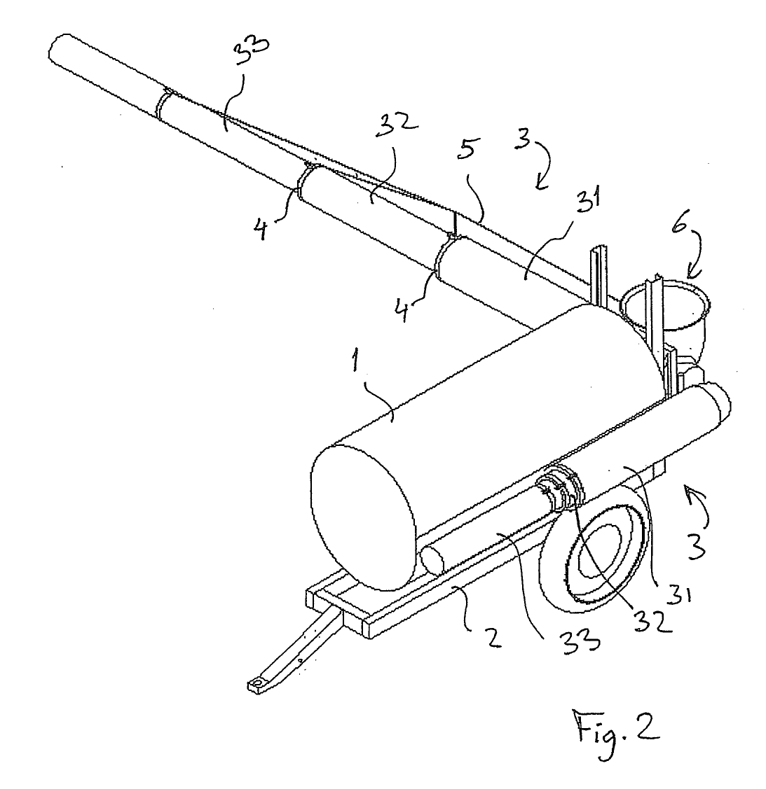

FIG. 2 is a perspective drawing of a field spraying device according to the invention.

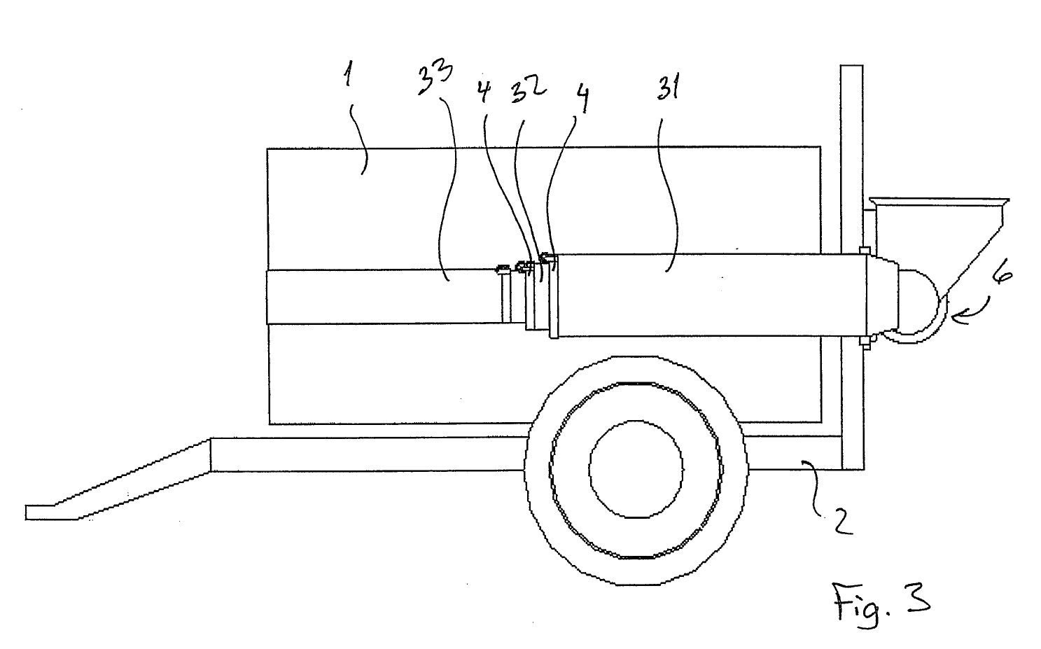

FIG. 3 is a side view hereof.

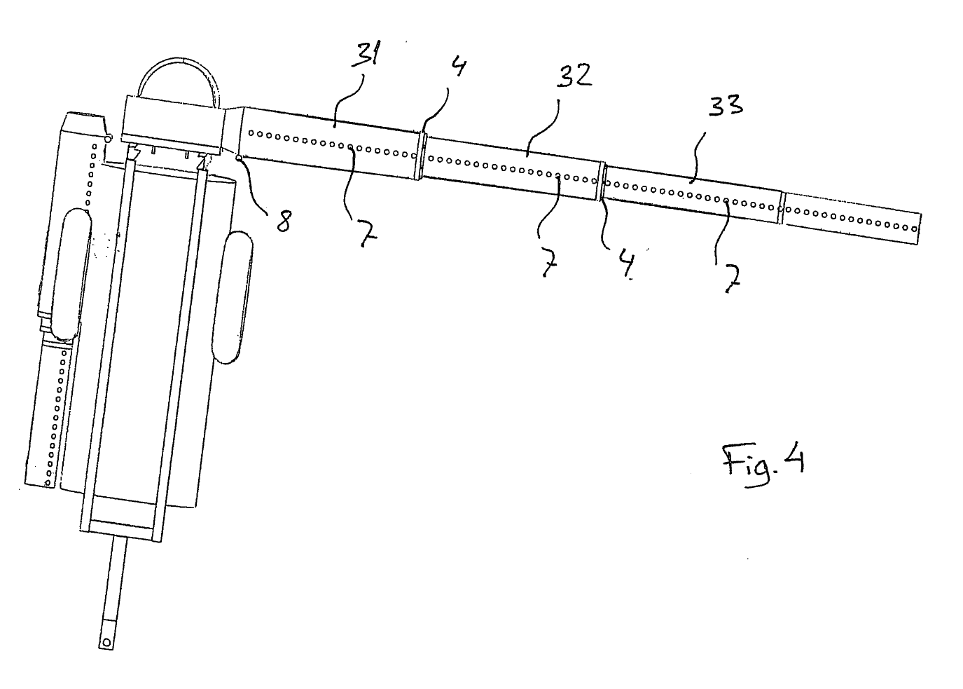

FIG. 4 illustrates a sprayer boom according to the invention seen from below.

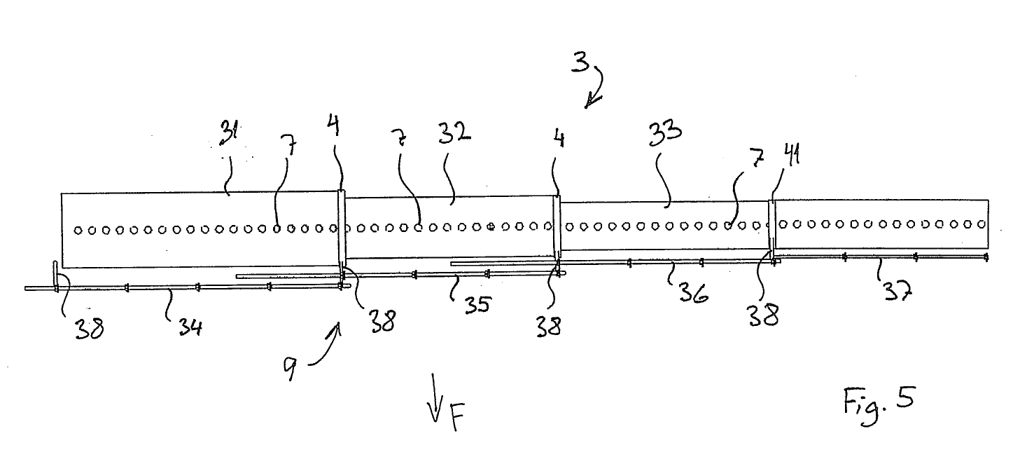

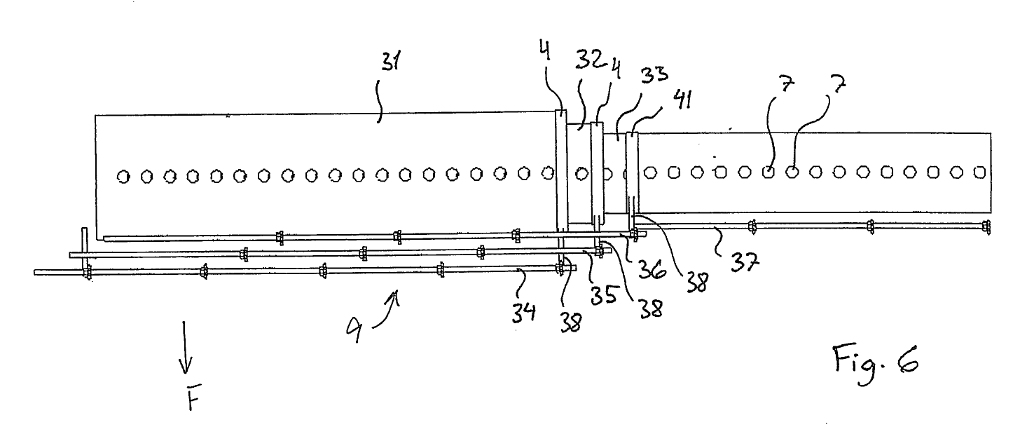

FIGS. 5 and 6 illustrates the sprayer boom according to a first embodiment seen from below in respectively elongated and retracted state.

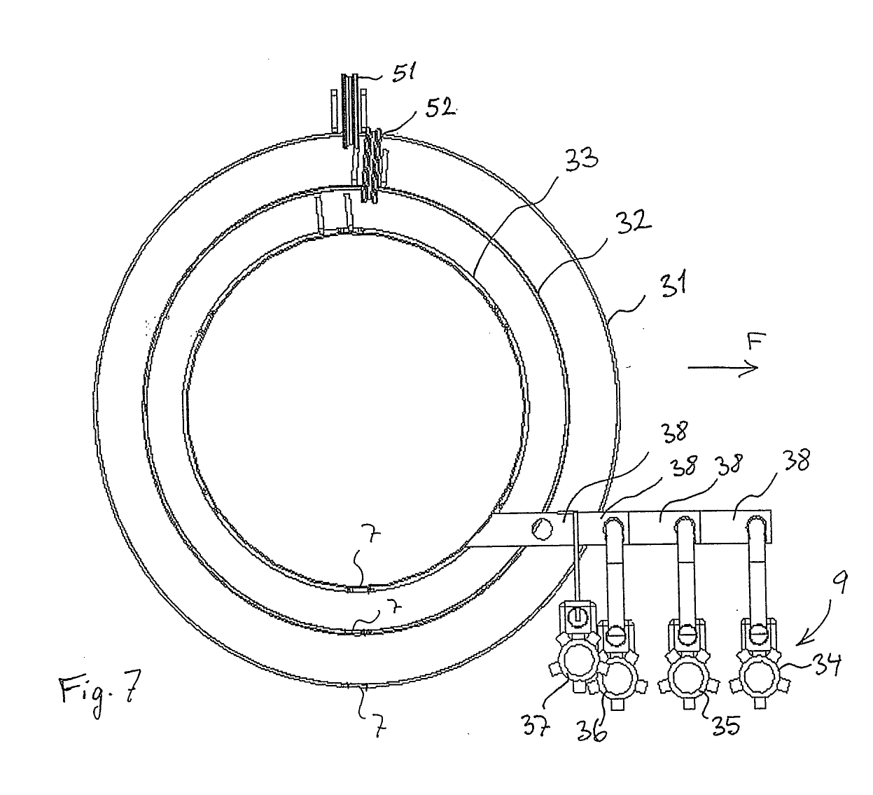

FIG. 7 illustrates a cross section of a first embodiment of a sprayer boom as illustrated in FIGS. 5 and 6 and

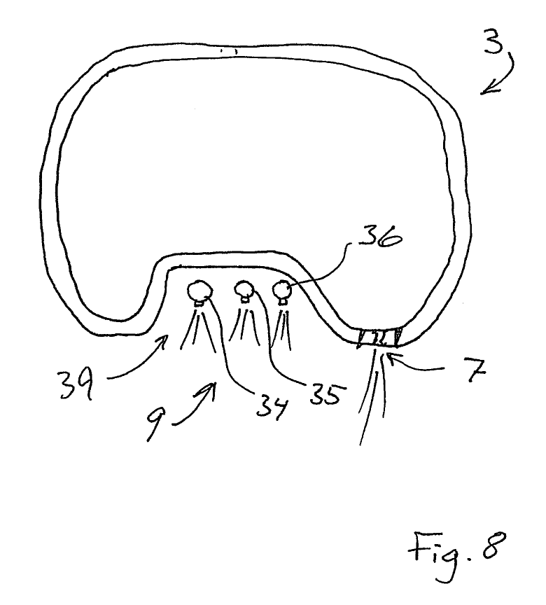

FIG. 8 illustrates an alternative cross section form of a sprayer boom according to the invention.

With reference to FIGS. 1 to 3, the field spraying device includes a container 1 which is mounted on a portable frame 2 preferably so that it can be attached behind a tractor or similar. Behind the tank attached to the field spraying device, a blower 6 which supplies the sprayer booms 3 with air is arranged. The booms 3 which are arranged on each side of the tank container are pivotally hanged up via hinge means 8 in the frame 2, so that they can be folded in when transporting as displayed at the left boom in the figures.

Each boom 3 includes a number of preferably concentric arranged pipe sections 31, 32, 33. The pipe sections displays different diameters e.g. respectively 50 centimetres, 40 centimetres and 30 centimetres. As illustrated by the drawings, the two inner pipe sections 31, 32 are one length e.g. 5 meters and the outer pipe section 33 can have a larger length. Each of the pipe sections 31, 32, 33 are preferably constructed in glass fibre and hanged up by the means of a wire arrangement 5 connected to the frame 2. The pipe sections are provided with a bushing 4 by which a tight transition between the pipe sections is secured. As illustrated in FIG. 4, the pipe sections 31, 32, 33 are provided with air holes 7. The air holes can be constructed as directional nozzles by which the air current from the nozzles 7 are regulated according to the direction of driving F and of the liquid nozzles 9 (see FIG. 5-8).

The sprayer boom 3 is as illustrated in FIGS. 5 to 7 provided with a liquid nozzle arrangement 9 which includes a number of nozzle pipes 34, 35, 36, 37. The nozzle pipes 34-37 are shiftably mounted in the sliding holders 38 which are attached at every bushing 4 at the end of the pipe sections 31, 32, 33. On the outer pipe section 33 there is arranged a bushing 41 which functions as a stop for the retraction of this outer pipe section 33 into the second outermost pipe section 32. As it also appears from the drawings, this outer pipe section 33 is preferably longer than the remaining pipe sections 31, 32, e.g. approximately twice as long. This outer pipe section 33 is provided with two nozzle pipes 36, 37 which are arranged parallel translated so that the second outermost nozzle pipe 36 also can push past the outer nozzle pipe 37 by retraction of the telescopic sprayer boom 3. As illustrated in FIG. 6, the liquid nozzle pipes 34-37 are however arranged parallel translated to each other so that the pipe sections 34-37 when retracting the sprayer boom 3 can be pulled together so that they are positioned in a parallel to each other at the inner pipe section 31 and nozzle pipe 34.

The nozzle pipes 34-37 are connected to the liquid container and a pumping device (not shown) by the means of flexible hoses (not shown) preferably from the inner ends of the nozzle pipes. Thereby the extention length of the sprayer boom can be regulated without compromising the functionality regarding the spraying of the liquid.

As illustrated in FIG. 7, the shifting mechanism 5 could include pulleys 51, 52 so that a wire pull (not shown) can be used for the mutual axial movement of the pipe sections in the sprayer boom for extension and retraction of the sprayer boom. The holders 38 for support and control of the nozzle pipes 34-37 can be of different lengths, so that the axial movement is controlled and thereby secured according to a predetermined pattern.

As indicated by the arrow F in the FIGS. 5 to 8, the preferred driving direction is, so that the liquid nozzles are in, front, by which the liquid sprayed from the nozzles is hit by the air blown out from the air nozzles and thereby gets atomized. Both nozzle arrangements are downward directed but preferably with a mutual acute angle to obtain the best effect and also the opening of the crop being sprayed so that it clears the way for a deeper and better penetration of the spraying liquid down into the crop which is sprayed instead of it just being deposited on the top leafs/part of the crop.

To achieve an extra stiffness, the sprayer boom can be supplied with a non-symmetrical rotating cross section. As illustrated in FIG. 8, the pipe sections 31-33 which comprise the telescopic sprayer boom can be constructed with a cross section with a greater bending moment of inertia than a circular pipe shape. Furthermore the pipe sections in the sprayer boom 3 can preferably be constructed with a longitudinal hollowness or cavity wherein the liquid nozzles 9, that is the nozzle pipes 34-36 are arranged and thereby protected. The air nozzles 7 are in this embodiment of the invention constructed in the front buckling of the sprayer boom 3 so that the desired effect with an acute mutual spraying angle and so the preferred orientation compared with the driving direction can be secured.

In the said embodiment examples, the sprayer boom is illustrated with three pipe sections but it is by the invention realised that there can be arranged an according to the invention's principles arbitrary number of concentric pipe sections which can be constructed with a suitable cylindrical shape also including a non-circular shape. Variants of the field spraying device and the sprayer boom according to the invention can be varied compared to the mentioned embodiments without deviation from the intent of the invention as mentioned in the enclosed claims.

1-32. (canceled)

33. A field spraying device comprising a liquid container attached to a mobile frame and with at least one sprayer boom, said least one sprayer boom comprises a number of sprayer nozzles and a number of downward directed air nozzles which are supplied with air from a central blower, wherein the least one sprayer boom is telescopic and displays a number of pipe sections with different diameters, wherein air is transported to downward directed air nozzles attached to one or more pipe sections.

34. A field spraying device according to claim 33, supplied with a sprayer boom pivotally mounted on the mobile frame.

35. A field spraying device according to claim 33, wherein the sprayer boom displays one or more pipe sections.

36. A field spraying device according to claim 33, wherein a number of air nozzles are arranged on all the pipe sections of the sprayer boom.

37. A fields spraying device according to claim 33, wherein the pipe sections are constructed in glass fibre.

38. A field spraying device according to claim 33, wherein the sprayer boom includes means for mutual lateral movement of the pipe sections for extension and retraction of the length of the sprayer boom.

39. A field spraying device according to claim 38, wherein the means for lateral movement comprises one or more pneumatic activated actuators.

40. A field spraying device according to claim 38, wherein the means for lateral movement comprises one or more hydraulic activated actuators.

41. A field spraying device according to claim 38, wherein the means for lateral movement comprises one or more electrically activated actuators.

42. A field spraying device according to claim 38, wherein the means for lateral movement comprises a wire pull.

43. A field spraying device according to claim 33, wherein one or more of the pipe sections of the sprayer boom include a deformation zone.

44. A field spraying device according to claim 33, wherein a flexible bag is attached to the outer part of the outermost pipe section.

45. A field spraying device according to claim 33, wherein the sprayer nozzles for spraying of the sprayer liquid are arranged on a nozzle pipe attached to the outer side of each pipe section and are in connection with the flow from the liquid container through a liquid pump.

46. A field spraying device according to claim 45, wherein the nozzle pipes are attached so as to be axially moveable on the pipe sections.

47. A field spraying device according to claim 33, wherein the field spraying device is provided with a sprayer boom on each side of the liquid container.

48. A field spraying device according to claim 47, wherein the two sprayer booms are identical.

49. A sprayer boom for a field spraying device according to claim 33, comprising a liquid transporting arrangement for providing of a liquid stream to a number of sprayer nozzles and wherein the sprayer boom is provided with a number of air nozzles and wherein the sprayer boom is telescopic and is provided with a number of pipe sections with different diameters, wherein air is supplied to downward directed air nozzles arranged on one or more pipe sections.

50. A sprayer boom according to claim 49, wherein the sprayer boom is provided with one or more pipe sections.

51. A sprayer boom according to claim 49, wherein a number of air nozzles are arranged on all the pipe sections of the sprayer boom.

52. A sprayer boom according to claim 49, wherein the pipe sections are constructed in glass fibre.

53. A sprayer boom according to claim 49, wherein the sprayer boom includes means for mutual lateral movement of the pipe sections for extension and retraction of the length of the sprayer boom.

54. A sprayer boom according to claim 53, wherein the means for lateral movement comprises one or more pneumatic activated actuators.

55. A sprayer boom according to claim 53, wherein the means for lateral movement comprises one or more hydraulic activated actuators.

56. A sprayer boom according to claim 53, wherein the means for lateral movement comprises one or more electrically activated actuators.

57. A sprayer boom according to claim 53, where the means for lateral movement comprises a wire pull.

58. A sprayer boom according to claim 49, wherein one or more of the pipe sections of the sprayer boom are supplied with a deformation zone.

59. A sprayer boom according to claim 49, wherein a flexible bag is attached to the outer part of the outermost pipe section.

60. A sprayer boom according to claim 33, wherein the sprayer nozzles for spraying sprayer liquid are arranged on a nozzle pipe attached to the outer side of each pipe section and which are in connection with the flow from the liquid container through a liquid pump.

61. A sprayer boom according to claim 60, wherein the nozzle pipes are attached so as to be axially moveable on the pipe sections.

62. A sprayer boom according to claim 49, wherein the sprayer boom displays a substantially circular cross section.

63. A sprayer boom according to claim 49, wherein the sprayer boom displays a cross section with an axial oriented cavity, wherein the nozzle pipes are arranged.

64. A sprayer boom according to claim 33, wherein the nozzle pipes are arranged in front of the air nozzles in relation to the driving direction of the field spraying device.
